(19) United States
(12) Patent Application Publication
(10) Pub. No.: US 2006/0269700 A1
(43) Pub. Date: Nov. 30, 2006

(54) Light reflective object and method

(76) Inventors: Neil A. Sater, Solvang, CA (US); Robert Dan Cunningham, Solvang, CA (US)

Correspondence Address: THOMPSON COBURN, LLP, ONE US BANK PLAZA, SUITE 3500, ST LOUIS, MO, 63101, US

(21) Appl. No.: 11/140,897

(22) Filed: May 31, 2005

(51) Int. Cl. G09F 19/00; A47G 33/04; G09F 17/00

(52) U.S. Cl. 428/11

(57) ABSTRACT

A light reflective object comprises an outer surface that defines a volume. The outer surface has at least first and second outer surface portions. The first and second surface portions are each convex and are each formed by a solid material that is at least partially transparent. The light reflective object further comprises opposite first and second reflective surfaces positioned within the volume between the first and second portions of the outer surface. Substantially all matter between the first reflective surface and the first outer surface portion consists of the solid material. Likewise, substantially all matter between the second reflective surface and the second outer surface portion consists of the solid material.

### BACKGROUND OF THE INVENTION

(1) Field of the Invention

The present invention pertains to light reflective objects of the type used to create unusual and aesthetically pleasing visual effects. More particularly, the present invention pertains to a light object that has light reflective surfaces surrounded by transparent lenses. The lenses distort light passing therethrough and the reflective surfaces reflect the light back through the lenses. This distortion and reflection creates an unusual sparkling effect that is aesthetically pleasing.

(2) General Background

Mirrors and lenses are often utilized to create visual effects for aesthetic or amusement purposes. Various decorative light reflective objects have also been developed specifically for aesthetic or amusement purposes. For example, U.S. Pat. Nos. 3,164,923, 6,592,706, and 5,811,159 each disclose various light reflective objects having various optical properties.

However, there remains a desire to achieve more interesting and aesthetically pleasing light reflective objects. Furthermore, the inventors of the present invention have appreciated the need to develop light reflective objects that simplistic in construction and relatively inexpensive to produce.

### SUMMARY OF THE INVENTION

The present invention relates to a light reflective object which has a simple construction and yet has increased visual appeal due to its ability to reflect and refract light in a unique manner.

In a first aspect of the invention, a light reflective object comprises an outer surface that defines a volume. The outer surface comprises at least first, second, and third outer surface portions. The first outer surface portion is convex and the second and third outer surface portions are separated from each other. Each of the second and third outer surface portions truncate the first outer surface portion. The light reflective object also comprises first and second reflective surfaces positioned within its volume and is configured and adapted to allow light to pass into the volume through the first, second, and third outer surface portions. Still further, the light reflective object is configured and adapted to allow light to reflect off of the first reflective surface and thereafter pass out of the volume through the first and second outer surface portions and to allow light to reflect off of the second reflective surface and thereafter pass out of the volume through the first and third outer surface portions.

In another aspect of the invention, a light reflective object comprises an outer surface that defines a volume. The outer surface has at least first and second outer surface portions. The first and second surface portions are each convex and are each formed by a solid material that is at least partially transparent. The light reflective object further comprises opposite first and second reflective surfaces positioned within the volume between the first and second portions of the outer surface. Substantially all matter between the first reflective surface and the first outer surface portion consists of the solid material. Likewise, substantially all matter between the second reflective surface and the second outer surface portion consists of the solid material. The light reflective object is configured and adapted to allow light to pass into the volume through the first and second outer surface portions. Additionally, the light reflective object is configured and adapted to allow light to reflect off of the first reflective surface and thereafter pass out of the volume through the first outer surface portion and to allow light to reflect off of the second reflective surface and thereafter pass out of the volume through the second outer surface portion.

In yet another aspect of the invention, a method comprises a step of providing a body of liquid. The liquid has a specific gravity. The method also comprises a step of providing a plurality of light reflective objects in a manner such that each of the light reflective objects has a specific gravity that is equal to the specific gravity of the liquid. Still further, the method comprises placing the plurality of light reflective objects within the body of liquid.

While the principal advantages and features of the invention have been described above, a more complete and thorough understanding of the invention may be obtained by referring to the drawings and the detailed description of the preferred embodiments, which follow.

### BRIEF DESCRIPTION OF THE DRAWINGS

FIG. 1 is a perspective view of a first embodiment of a light reflective object in accordance with the present invention.

FIG. 2 is an exploded side elevation view of the light reflective object of FIG. 1.

FIG. 3 is a representation of plurality of light reflective objects having different buoyancy properties in accordance with the invention.

FIG. 4 shows an example of a use of light reflective objects in accordance with the invention as part of a flower vase display.

FIG. 5 shows another example of a use of light reflective objects in accordance with the invention in connection with a water fountain.

FIG. 6 is a perspective view of a second embodiment of a light reflective object in accordance with the present invention.

FIG. 7 is an exploded side elevation view of the light reflective object of FIG. 6.

Reference characters in the written specification indicate corresponding items shown throughout the drawing figures.

### DETAILED DESCRIPTION OF THE PREFERRED EMBODIMENTS OF THE INVENTION

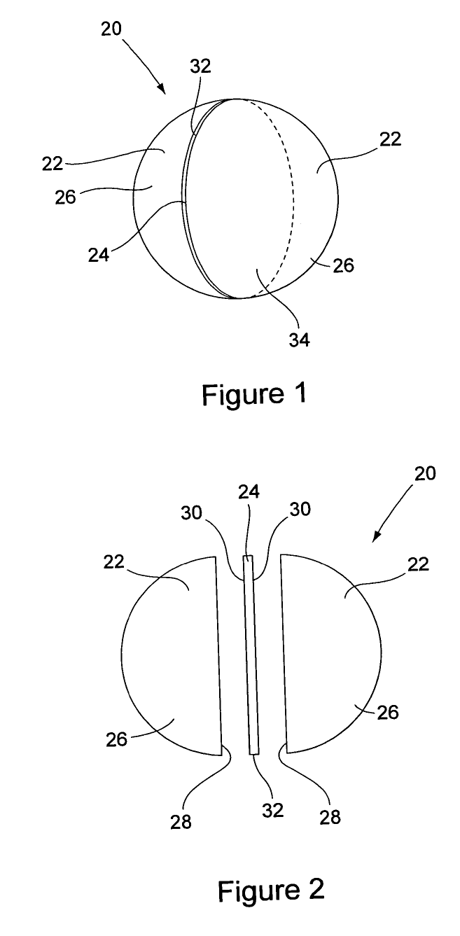

FIG. 1 shows a perspective view of a first embodiment of a light reflective object 20 in accordance with the present invention. An assembly view of the light reflective object is shown in FIG. 2. The object 20 generally comprises a pair of generally hemispherical lenses 22 and a light reflective member 24.

Preferably, the lenses 22 of the light reflective object 20 of the first embodiment are equally dimensioned solid hemispheres formed of at least partially transparent material such as plastic or glass. As such, the lenses 22 comprise an outer hemispherical surface 26 and a planer circular surface 28. However, it should be appreciated that the lenses may alternatively be non-hemispherical and need not necessarily be similar in shape and size to each other. Additionally, the material comprising the hemispherical shaped lenses 22 may be material that is impact resistant so as to minimize the risk of breakage and/or chipping when multiple light reflective objects 20 are used in dynamic visual display.

The light reflective member 24 is preferably a piece of sheet material such as mylar foil having opposite reflective surfaces 30. Preferably, the light reflective member 24 has a circular perimeter edge 32 and is dimensioned such that each of the opposite light reflective surfaces 30 are equal in size and shape to the circular surfaces 28 of the lenses 22. Additionally, the light reflective member 24 is preferably much thinner than the overall diameter of the lenses 22. Furthermore, the light reflective member 24 is preferably positioned between the lenses 22 in a manner such that the circular surfaces 28 of the lenses extend adjacent the opposite reflective surfaces 30 of the light reflective member. Preferably the circular surfaces 28 of the lenses 22 are adhered to the opposite reflective surfaces 30 of the light reflective member 24 via a waterproof and transparent adhesive. Alternatively, the lenses 22 may be sintered together with the light reflective member 24 therebetween or may be molded as single monolithic piece around the light reflective member. Still further, other methods of manufacturing known to those of ordinary skill in the art could be utilized to form the light reflective object and are considered to be within the scope of the invention.

When fully assembled, the light reflective object 20 is generally spherical in shape and has a generally spherical outer surface 34 formed by the outer hemispherical surfaces 26 of the lenses 22 and the perimeter edge 32 of the light reflective member 24. It should be appreciated that the lenses 22 of the light reflective object 20 have a refractive index and that such refractive index is larger than that of air and water. For example, air has a refractive index of approximately 1.0003, water has a refractive index of approximately 1.3316, glass has a refractive index of approximately 1.5171, and Plexiglas® plastic has a refractive index of approximately 1.50. Thus, when the light reflective object is in a water or air environment, light striking the outer surface 34 of the light reflective object 20 from the environment will be diffracted as it enters the light reflective object. Moreover, because the lenses 22 are convex, light from a given direction will partially converge as it passes through one of the lenses. In most cases, this partially converged light ultimately reflects off one of the reflective surfaces 30 of the light reflective member 24 and thereafter passes back through the lens and through the outer surface 34 of the light reflective object 20 into the environment surrounding the object. As the light passes through the outer surface 34 of the light reflective object 20 into the environment surrounding the object, it is further converged and ultimately the light reaches a focal-point after which it diverges.

In general, the effect described above is similar to the effect of light passing through a transparent glass sphere, except that the light passing into the light reflective object 20 is redirected by one of the reflective surfaces 30 and is therefore directed back out of the same hemisphere that it entered. Hence, the light reflective object 20 produces interesting and aesthetically pleasing visual effects regardless of what is behind the light reflective object. It should also be appreciated that this effect is different form the visual properties of created by substantially hollow light reflective objects in that substantially hollow objects tend to counteract or negate the diffraction effects created by the light reflective objects of the present invention.

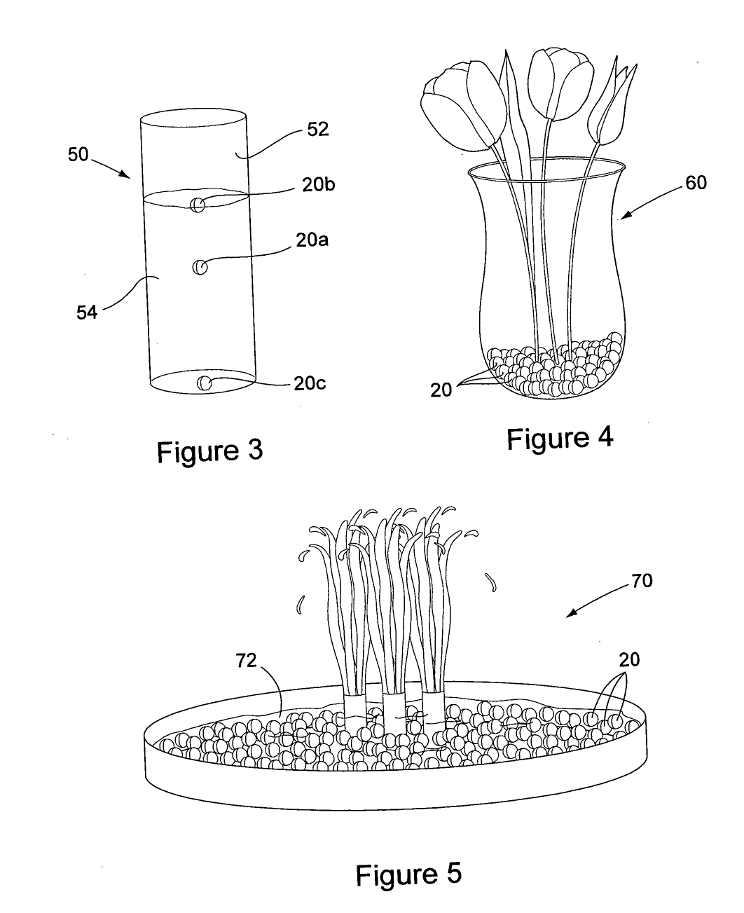

The inventors of the present invention have also appreciated that the specific gravity of the light reflective object 20 can be altered to achieve various desirable properties. In particular, controlling the specific gravity of the light reflective object 20 can be used to control the buoyancy of the reflective object in a body of liquid. To illustrate this aspect of the invention, a liquid filled container 50 is depicted in FIG. 3. The liquid filled container comprises a container 52 and a body of liquid 54. A first light reflective object 20a is depicted as hovering in the body of liquid 54. In other words, light reflective object 20a has neither tends to float nor sink in the body of liquid 54. This is achieved by controlling the total mass to volume ratio of the light reflective object 20a to be approximately equal to the mass to volume ratio of the body of liquid 54. The total mass to volume ratio of the light reflective object 20a can be controlled, among other ways, by selecting various different materials with different densities to form the lenses 22 and the light reflective member 24 and by altering the volume ratio between the lenses and the light reflective member. Thus it should also be appreciated that another light reflective object 20b can be formed that has a specific gravity less than that of the liquid so as to make the light reflective object buoyant in the liquid. Likewise, yet another light reflective object 20b can be formed having a specific gravity greater than that of the liquid so as to cause the light reflective object sink in the liquid.

In view of the foregoing, it should be appreciate that various uses can be made of light reflective objects in accordance with the invention. For example, the light reflective objects 20 can be utilized in static display such as a clear vase 60 as depicted in FIG. 4 to enhance the aesthetics of the vase. As another example, a plurality of light reflective objects 20 could be dynamically displayed in the collection basin of water fountain 70 as depicted in FIG. 5. To this end, some or all of the light reflective objects 20 could be formed to hover and drift within the water. Still further the light reflective objects 20 could be placed or attached to virtually any surface to provide aesthetically pleasing and interesting reflections.

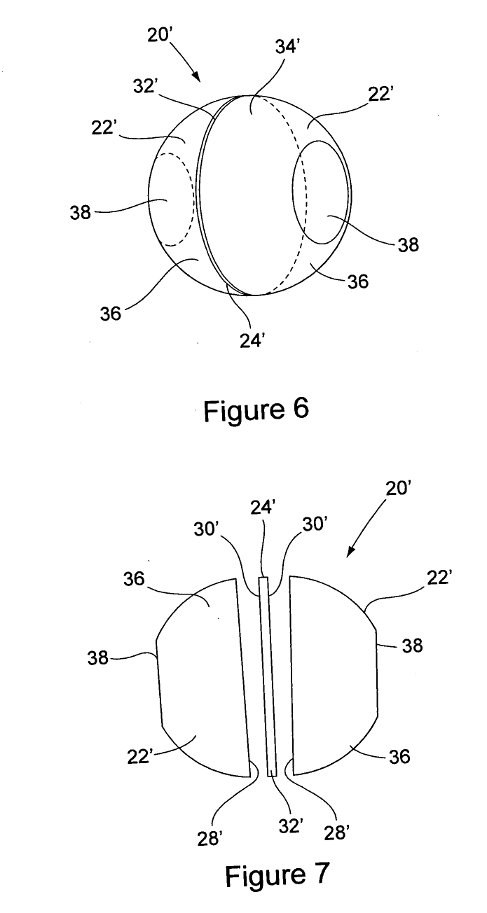

It should also be appreciated the light reflective objects need not necessarily be spherical. For example, a second embodiment of a light reflective object 20′ in accordance with the invention is shown in FIGS. 6 and 7. This second embodiment of a light reflective object 20′ is similar to the light reflective object 20 of the first embodiment and includes a pair of lenses 22′ and light reflective member 24′ arranged and assembled in much the same way as the first embodiment. Additionally, the light reflective member 24′ of the second embodiment is preferably identical to the light reflective member 24 of the first embodiment and, as such, has opposite circular reflective surfaces 30′ and a perimeter edge 32′. However, the lenses 22′ of this second embodiment have a slightly different configuration. In particular, rather than having an outer hemispherical surface, each of the lenses 22′ is truncated in a manner such that it has an outer semispherical surface 36 that is clipped by a truncating surface 38. Thus, the outer surface 34′ of the light reflective object 20′ comprises the outer spherical surfaces 36 and truncating surfaces 38 of the lenses 22′ and the perimeter edge 32′ of the light reflective member 24′. Preferably, each of the truncating surfaces is planar and is preferably parallel to the circular surface 28′ of the lens 22′ that faces the light reflective member 24′. Additionally, each truncating surfaces 38 preferably has a relatively small diameter so as to preserve the overall spherical quality of the light reflective object 20′ (i.e., permit it to roll).

In view of the configuration of the lenses 22′ of the light reflective object 20′ of the second embodiment, it should be appreciated that the outer semispherical surface 36 of each lens functions similar to hemispherical surfaces 26 of the lenses 22 of the light reflective object 20 of the first embodiment. However, it should also be appreciated that light passing through the planar truncating surface 38 diffracts but does not refocus (i.e. converge or diverge) as it would when passed through a concave or convex surface. As such, the light reflective object 20′ of the second embodiment creates reflective effects that differ for those of the light reflective object 20 of the first embodiment, which in some cases may be aesthetically preferable.

While the present invention has been described in reference to a specific embodiment, in light of the foregoing, it should be understood that all matter contained in the above description or shown in the accompanying drawings is intended to be interpreted as illustrative and not in a limiting sense and that various modifications and variations of the invention may be constructed without departing from the scope of the invention defined by the following claims. For example, it should be appreciated that the light reflective member need not be formed from an separate piece of material and could be any reflective material such as a layer of reflective paint or reflective adhesive that also acts to adhere the lenses together. Additionally, the light reflective objects need not be any particular size or shape. Still further, the light reflective objects may have non-symmetrical lenses. It may also be desirable to select only materials that are inert and impervious to various types of liquid media, for instance water and/or oil. Thus, other possible variations and modifications should be appreciated.

Furthermore, it should be understood that when introducing elements of the present invention in the claims or in the above description of the preferred embodiment of the invention, the terms “comprising,” “including,” and “having” are intended to be open-ended and mean that there may be additional elements other than the listed elements. Similarly, the term “portion” should be construed as meaning some or all of the item or element that it qualifies.

What is claimed is:

1. A light reflective object comprising:
an outer surface defining a volume, the outer surface comprising at least first, second, and third outer surface portions, the first outer surface portion being convex, the second and third outer surface portions being separated from each other, each of the second and third outer surface portions truncating the first outer surface portion; and
first and second reflective surfaces positioned within the volume;
the light reflective object being configured and adapted to allow light to pass into the volume through the first, second, and third outer surface portions, the light reflective object also being configured and adapted to allow light to reflect off of the first reflective surface and thereafter pass out of the volume through the first and second outer surface portions and to allow light to reflect off of the second reflective surface and thereafter pass out of the volume through the first and third outer surface portions.

2. A light reflective object in accordance with claim 1 wherein the first and second outer surface portions and the first and second reflective surfaces are each planar and are each parallel to each other.

3. A light reflective object in accordance with claim 1 wherein the first and second reflective surfaces each have a periphery, and wherein a majority of the periphery of each of the first and second reflective surfaces intersects the outer surface of the light reflective object.

4. A light reflective object in accordance with claim 1 wherein the first outer surface portion is semispherical.

5. A light reflective object in accordance with claim 1 wherein the second outer surface portion and at least part of the first outer surface portion are formed by solid material that is at least partially transparent and that extends adjacent the first reflective surface in a manner such that substantially all matter between the first reflective surface and the second outer surface portion consists of the solid material.

6. A light reflective object in accordance with claim 5 wherein the first and second outer surface portions and the first and second reflective surfaces are each planar and are each parallel to each other.

7. A light reflective object in accordance with claim 5 wherein the first outer surface portion is semispherical.

8. A light reflective object in accordance with claim 5 wherein the first and second reflective surfaces each have a periphery, and wherein a majority of the periphery of each of the first and second reflective surfaces intersects the outer surface of the light reflective object.

9. A light reflective object in accordance with claim 5 wherein the first and second outer surface portions and the first and second reflective surfaces are each planar and are each parallel to each other, the first outer surface portion is semispherical, the first and second reflective surfaces each have a periphery, and a majority of the periphery of each of the first and second reflective surfaces intersects the outer surface of the light reflective object.

10. A method comprising:
providing a body of liquid, the liquid having a first specific gravity;
providing a plurality of light reflective objects that are each in accordance with the light reflective object of claim 1, the providing being performed in a manner such that each of the light reflective objects has a specific gravity that is approximately equal the specific gravity of the liquid; and
placing the plurality of light reflective objects within the body of liquid.

11. A light reflective object comprising:
an outer surface defining a volume, the outer surface having at least first and second outer surface portions, the first and second surface portions each being convex and each being formed by a solid material that is at least partially transparent; and
opposite first and second reflective surfaces positioned within the volume between the first and second portions of the outer surface, substantially all matter between the first reflective surface and the first outer surface portion consisting of the solid material, substantially all matter between the second reflective surface and the second outer surface portion consisting of the solid material;
the light reflective object being configured and adapted to allow light to pass into the volume through the first and second outer surface portions, the light reflective object also being configured and adapted to allow light to reflect off of the first reflective surface and thereafter pass out of the volume through the first outer surface portion and to allow light to reflect off of the second reflective surface and thereafter pass out of the volume through the second outer surface portion.

12. A light reflective object in accordance with claim 11 wherein the first and second outer surface portions are each substantially hemispherical and substantially equal in diameter.

13. A light reflective object in accordance with claim 11 wherein the first and second reflective portions are each planar.

14. A light reflective object in accordance with claim 11 wherein the first and second reflective surfaces each have a periphery, and wherein a majority of the periphery of each of the first and second reflective surfaces intersects the outer surface of the light reflective object.

15. A light reflective object in accordance with claim 11 wherein the first and second reflective surfaces are opposite faces of a piece of the reflective sheet material, and wherein the first and second surface portions are each formed by separate first and second pieces of the solid material.

16. A light reflective object in accordance with claim 15 wherein the first piece of the solid material is adhered to the first reflective surface of the piece of reflective sheet material via an adhesive, and wherein the second piece of the solid material is adhered to the second reflective surface of the piece of reflective sheet material via an adhesive.

17. A light reflective object in accordance with claim 11 wherein the solid material is a plastic material.

18. A method comprising:
providing a body of liquid, the liquid having a specific gravity;
providing a plurality of light reflective objects that are each in accordance with the light reflective object of claim 11, the providing being performed in a manner such that each of the light reflective objects has a specific gravity that is approximately equal the specific gravity of the liquid; and
placing the plurality of light reflective objects within the body of liquid.

19. A method comprising:
providing a body of liquid, the liquid having a specific gravity;
providing a plurality of light reflective objects that are each in accordance with the light reflective object of claim 11, the providing being performed in a manner such that each of the light reflective objects has a specific gravity that is less than the specific gravity of the liquid; and
placing the plurality of light reflective objects within the body of liquid.

20. A method comprising:
providing a body of liquid, the liquid having a specific gravity;
providing a plurality of light reflective objects that are each in accordance with the light reflective object of claim 11, the providing being performed in a manner such that each of the light reflective objects has a specific gravity that is greater than the specific gravity of the liquid; and
placing the plurality of light reflective objects within the body of liquid.
